(19) United States
(12) Patent Application Publication
(10) Pub. No.: US 2008/0236965 A1
(43) Pub. Date: Oct. 2, 2008

(54) TRANSPORTATION DEVICE

(76) Inventors: Hideyuki NAKAMURA, Kudamatsu-shi (JP); Takeshi Kawasaki, Kudamatsu-shi (JP); Toshihiko Mochida, Kudamatsu-shi (JP); Takashi Yamaguchi, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/841,017

(22) Filed: Aug. 20, 2007

(30) Foreign Application Priority Data
Mar. 28, 2007 (JP) 2007-085370

(51) Int. Cl. F16F 9/30

(52) U.S. Cl. 188/268

(57) ABSTRACT

The invention provides a transportation device having a shock absorbing device with a reduced non-collapse region. Shock absorbers 14 and 17 constituting a shock absorbing device 10A provided on a transportation device is connected respectively to shock absorbers 17 and 20 disposed rearward therefrom via connecting members 23 and 26 having ashtray-like cross-sectional shapes. The shock absorber 20 disposed at the rearmost position is connected via welding to a base 29. Collapse regions 15, 18 and 21 of the shock absorbers 14, 17 and 20 are collapsed by the load applied to the shock absorbers 14, 17 and 20, and their lengths are shortened. Non-collapse regions 16 and 19 of the shock absorbers 14 and 17 overlap respectively with the non-collapse regions 19 and 22 of the shock absorbers 17 and 20 disposed rearward therefrom. Therefore, the non-collapse regions 16, 19 and 22 fit within a recessed portion of the connecting members 23 and 26, and the overall longitudinal length of the non-collapse regions of the shock absorbing device can be shortened.

The present application is based on and claims priority of Japanese patent application No. 2007-85370 filed on Mar. 28, 2007, the entire contents of which are hereby incorporated by reference.

### BACKGROUND OF THE INVENTION

1. Field of the Invention

The present invention relates to transportation devices including railway vehicles such as railway cars or monorail cars and automobiles anticipated to receive shock by collision. The present invention specifically relates to railway cars equipped with a shock absorbing device composed of shock absorbers formed of a material having superior shock absorption property for absorbing the shock occurring during collision.

2. Description of the Related Art

In conventional railway cars, crushable zones for absorbing the shock received during collision are desirably provided in the car body so as to ensure the safety of passengers and crew during collision. With respect thereto, Japanese Patent No. 3725043 (patent document 1) proposes providing shock absorbing devices at longitudinal end portions of the front car (including the rearmost car) and the intermediate cars, so as to receive the load applied to the car body during collision by the shock absorbing devices and relieve the shock.

In a railway car body structure, it is desired that the shock received during collision is absorbed by a crushable zone taking up as small a space as possible to ensure sufficient cabin space. However, a non-collapsed residue remains after the crushing of the shock absorber, so the shock must actually be absorbed by the region excluding this non-collapse region. In other words, the non-collapse region becomes a dead zone within the crushable zone that does not contribute to absorbing shock.

Thus, by minimizing the non-collapse region, the crushable zone can be effectively reduced and the cabin space of the transportation device can be effectively expanded.

### SUMMARY OF THE INVENTION

The object of the present invention is to provide a transportation device having a shock absorbing device capable of minimizing the non-collapse region as much as possible.

In order to achieve the above objects, the present invention provides a transportation device having a shock absorbing device composed of a shock absorber for absorbing shock, wherein the shock absorbing device comprises a plurality of said shock absorbers disposed in a shock acting direction; with respect to two shock absorbers of the plurality of shock absorbers constituting the shock absorbing device, a rear end portion of a shock absorber disposed frontward in the shock receiving direction is inserted to and overlapped with a front end portion of the shock absorber disposed rearward therefrom; or the rear end portion of the shock absorber disposed frontward in the shock receiving direction covers and overlaps with the front end portion of the shock absorber disposed rearward therefrom; and the shock absorber on the front side and the shock absorber on the rear side are connected via a connecting member along the shock acting direction.

According to the present transportation device, the non-collapse region of the shock absorber disposed on the front side of the shock absorbing device overlaps with the non-collapse region of the shock absorber disposed on the rear side, so that the non-collapse region of the shock absorbing device is minimized, according to which the overall length of the shock absorbing device can be reduced.

Since according to the present invention, the non-collapse region of the shock absorbing device can be minimized, the crushable zone can be reduced in size, and thus, the transportation device can have wider cabin space.

### BRIEF DESCRIPTION OF THE DRAWINGS

FIG. 1 is a vertical cross-sectional view showing one embodiment of a shock absorbing device according to the present invention;

FIG. 2 is a view taken toward the direction of the arrow from line II-II of FIG. 1;

FIG. 3 is a perspective view of the railway car body structure;

FIG. 4 is a comparison view of the present shock absorbing device and a prior art shock absorbing device having been collapsed;

FIG. 5 is a vertical cross-sectional view showing another embodiment of the shock absorbing device according to the present invention;

FIG. 6 is a view taken toward the direction of the arrow from line VI-VI of FIG. 5;

FIG. 7 is a vertical cross-sectional view showing another embodiment of the shock absorbing device according to the present invention;

FIG. 8 is a view taken toward the direction of the arrow from line VIII-VIII of FIG. 7; and

FIG. 9 is a vertical cross-sectional view showing yet another embodiment of the shock absorbing device according to the present invention.

### DETAILED DESCRIPTION OF THE PREFERRED EMBODIMENTS

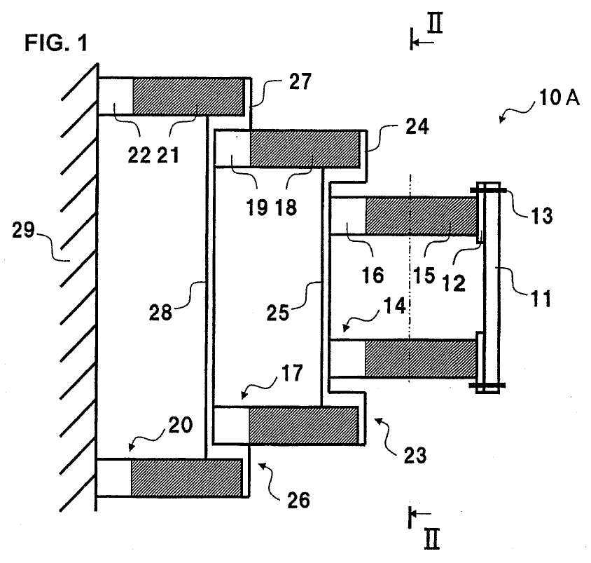

One preferred embodiment of a transportation device according to the present invention will be described with reference to FIGS. 1 through 3.

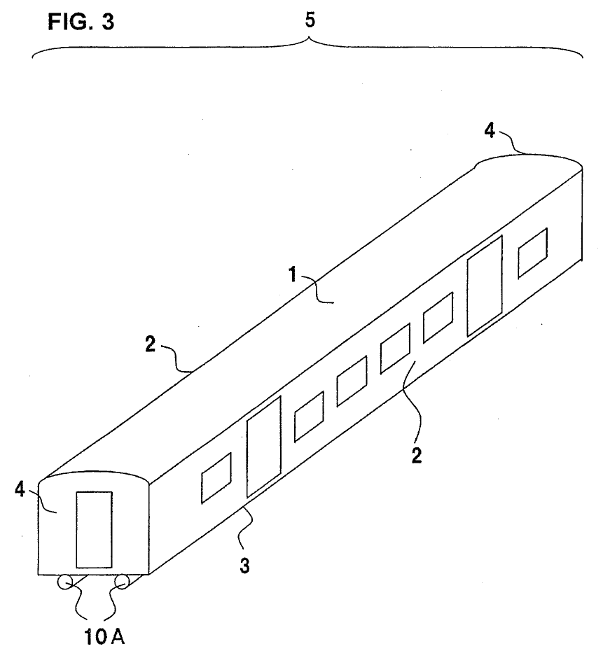

In FIG. 3, reference number 5 denotes a structure of a railway car being one example of a transportation device, which is composed of a roof structure 1 constituting an upper plane thereof, two side structures 2 and 2 constituting side walls thereof, an underframe 3 constituting a bottom plane thereof, and two end structures 4 and 4 constituting end walls thereof. The roof structure 1, the side structures 2 and 2, the underframe 3 and the end structures 4 and 4 are each formed by welding a plurality of extruded shape members. The extruded shape members constituting the roof structure 1, the side structures 2 and 2 and the underframe 3 are formed of hollow shape members made of aluminum alloy, and the direction of extrusion thereof correspond to the front-rear direction of the railway car body structure 5. The extruded shape members constituting the end structures 4 and 4 are shape members with ribs made of aluminum alloy, and the direction of extrusion thereof corresponds to the height direction of the railway car body structure 5. A shock absorbing device 10A is disposed toward the longitudinal direction on the lower plane of the underframe 3 at the longitudinal end of the railway car body structure 5.

In FIG. 3, the left end is illustrated as the leading end, but in FIG. 1, the right end is illustrated as the leading end. At the right end of FIG. 1 is a load acting portion.

The shock absorbing device 10A has a load acting portion 11 disposed at a leading end (right end) thereof, and shock absorbers 14, 17 and 20 disposed rearward therefrom (left side) The shock absorber 14 and the shock absorber 17 disposed adjacent to one another along the transmission path of the load is connected via a connecting member 23, and the shock absorber 17 and the shock absorber 20 disposed adjacent to one another along the load transmission path is connected via a connecting member 26. The shock absorber 20 is connected to the lower plane of the underframe 3 of the railway car body structure 5 via a base 29.

The shock absorbers 14, 17 and 20 are hollow extruded shape members having an octagonal cross-sectional shape and formed of a material having superior shock absorbing property, such as aluminum alloy extruded shape members A6063S-T5, and the outer diameters of the shock absorbers 14, 17 and 20 are gradually increased toward shock absorbers 17 and 20 disposed in the rearward direction (toward the left side in the drawing) with respect to the load acting direction. The cross-sectional areas of the shock absorbers 14, 17 and 20 are gradually increased toward the shock absorbers disposed in the rearward direction.

Now, we will describe in detail the definition of the aforementioned term “outer diameter”. Though the shock absorbers 14, 17 and 20 have octagonal perpendicular cross-sectional shapes and not round cross-sectional shapes with respect to the direction of extrusion thereof, the diameters of the circumscribed circles thereof are considered as their “outer diameters”. Further, the shapes of the shock absorbers 14, 17 and 20 are not restricted to octagonal shapes, but can be hexagonal shapes or polygonal shapes having greater number of sides. The same definition applies for the term “circular” in the claims.

The shock absorber 14 (17, 20) is composed of an inner cylinder face plate, an outer cylinder face plate and connecting plates connecting the two face plates in trusses. Therefore, shock absorbers 14, 17 and 20 are hollow extruded shape members. The hollow extruded shape members have closed cross-sectional shapes. Further, each hollow extruded shape member has a hollow space penetrating the center portion along the center of axle of the direction of extrusion thereof.

Further, the center of axle in the direction of extrusion of the shock absorber (hollow extruded shape member) 14 corresponds to the center of axle of the other shock absorbers (hollow extruded shape members) 17 and 20. In other words, the center axes of the shock absorbers 14, 17 and 20 (hollow extruded shape members) correspond. The front end of the shock absorber 14 is connected via fillet welding to a closing plate 12. The closing plate 12 is connected to the load acting portion 11 disposed frontward via bolts and nuts 13. The load acting portion 11 is a thick plate.

The rear end of the shock absorber 14 (17) is inserted to the front end of the shock absorber 17 (20) disposed adjacent thereto along the load transmission path, and a portion of the existence range of the shock absorber overlaps with the existence range of the other shock absorber in the direction of the center axis thereof. The rear end of the shock absorber 14 (17) and the front end of the shock absorber 17 (20) are connected via a connecting member 23 (26).

The connecting member 23 (26) is a thick plate. The connecting member 23 (26) is attached via fillet welding to the shock absorber 14 (17) disposed frontward therefrom and to the shock absorber 17 (20) disposed rearward therefrom.

The connection between the rear end of the shock absorber 14 (17) and the shock absorber 17 (20) via the connecting member is realized through welding or through engagement using bolts and nuts. The welding is, as described above, fillet welding. The connection using bolts and nuts is realized by fillet-welding a plate to the front end of the shock absorber 17 (20) and connecting the overlapped portions between the plate and the outer circumference of the connecting member 23 (26) using bolts and nuts. The nuts can be omitted. The bolts are engaged from the side closer to the load acting portion 11. The connection between the shock absorber 14 (17) and the connecting member 23 (26) is realized in a similar manner.

Further, the rear end of the shock absorber 17 and the front end of the shock absorber 20 are connected via a connecting member 26 in a similar manner as described above.

The rear end of the shock absorber 20 is welded to the base 29. The base 29 is disposed on a lower portion of the underframe 3.

The base 29 is connected via bolts (not shown) to the railway car body structure 5, and by removing these bolts, the shock absorbing device 10A can be easily replaced.

The shock absorbers 14, 17 and 20 are respectively divided into collapse regions 15, 18 and 21 and non-collapse regions 16, 19 and 22. The regions absorbing shock at the time of collision are collapse regions 15, 18 and 21, and the non-collapse regions 16, 19 and 22 are dead zones which do not absorb shock.

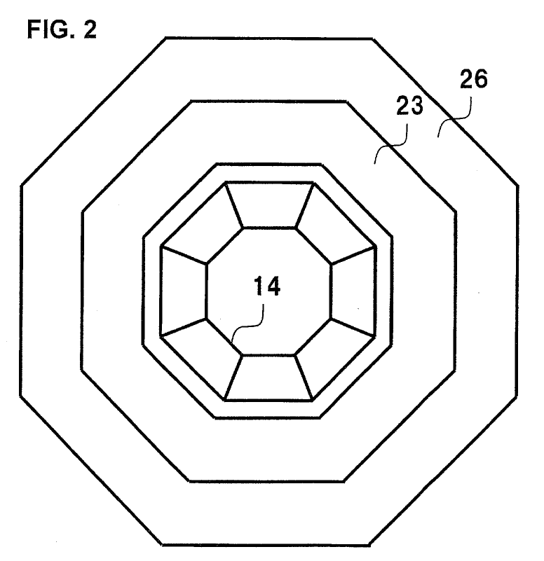

As illustrated in FIG. 2, the shape of the connecting members 23 and 26 is, when seen from the front (frontward direction), a double octagon. That is, the shock absorbers 14 and 17 to which the connecting members are inserted are octagonal, and the shock absorbers 17 and 20 receiving the connecting members 23 and 26 are also octagonal. The connecting members 23 and 26 have a somewhat ashtray-like shape in which inner receiving portions 25 and 28 are respectively formed as a stepped lower portion of the outer receiving portions 24 and 27. The inner receiving portions 25 and 28 are respectively welded to the shock absorbers 14 and 17 disposed frontward therefrom and the outer receiving portions 24 and 27 are respectively welded to the shock absorbers 17 and 20 disposed rearward therefrom.

As for the connecting member 23 (26), the longitudinal distance (in the load acting direction) between the outer receiving unit 24 (27) disposed frontward and the inner receiving portion 25 (28) disposed rearward is substantially equal to the longitudinal length of the non-collapse region 16 (19) of the front shock absorber 14 (17) and the non-collapse region 19 (22) of the rear shock absorber 17 (20).

In other words, the longitudinal lengths of the non-collapse regions 16, 19 and 22 of the shock absorbers 14, 17 and 20 are substantially equal. Each longitudinal length is substantially equal to the longitudinal distance between the outer receiving portion 24 and the inner receiving portion 25 of the connecting member 23, and to the longitudinal distance between the outer receiving portion 27 and the inner receiving portion 28 of the connecting member 26.

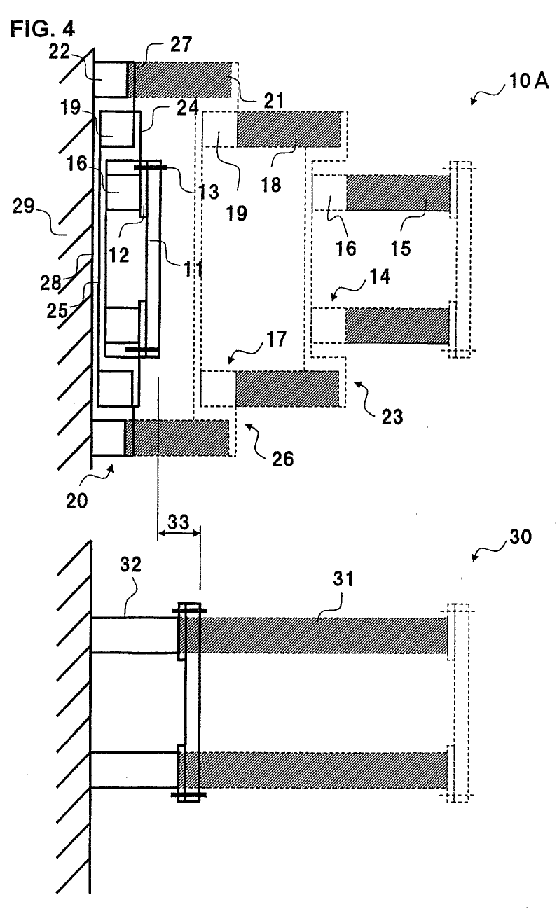

According to such structure, the non-collapse region of the shock absorbing device 10A can be minimized. FIG. 4 illustrates a comparison of the collapsed states of the shock absorbing device 10A according to the present invention and the shock absorbing device 30 according to the prior art. The upper drawing illustrates the state in which the shock absorbing device 10A according to the present invention is collapsed by shock. The lower drawing illustrates the state in which the prior art shock absorbing device 30 having a length equivalent to the longitudinal length (in the load acting direction) of the shock absorbing device 10A according to the present invention illustrated in the upper drawing is collapsed.

In the shock absorbing device 10A, ¾ of the length of each shock absorber 14, 17 and 21 is collapsed and ¼ remains as the non-collapsed portion. The non-collapsed portion includes the remaining length of the collapsed and shrunk portion. The same applies for the shrunk prior art shock absorbing device 30.

As for the shock absorbing device 10A, since the non-collapse regions 16 and 19 of the shock absorbers 14 and 17 are inserted respectively to the areas of the non-collapse regions 19 and 22 of the shock absorbers 17 and 20 disposed rearward therefrom, the overall non-collapse region of the shock absorbing device 10A is minimized, becoming smaller than the non-collapse region 32 corresponding to ¼ the length of the prior art shock absorbing device 30.

According to the present shock absorbing device 10A, the shock is absorbed via collapse regions 15, 18 and 21, whereas according to the shock absorbing device 30, shock is absorbed via the collapse region 31. This difference is equivalent to the longitudinal length difference 33 between the non-collapse regions of the shock absorbing device 10A and the shock absorbing device 30. In other words, the shock absorbing device 10A is capable of absorbing greater shock corresponding to the longitudinal length difference 33 of the non-collapse regions compared to the shock absorbing device 30.

Thereby, the shock absorbing device 10A can absorb equivalent amount of shock as the shock absorbing device 30 with a smaller longitudinal length than the shock absorbing device 30. In other words, by adopting the present shock absorbing device 10A, it becomes possible to shrink the crushable zone, and thereby, to widen the cabin space.

We will now describe the term “shrink” mentioned above. If they are of the same length, the shock absorbing quantity of the shock absorbing device 10A is greater than that of the shock absorbing device 30. In other words, the length required to absorb the same amount of shock is shorter for the shock absorbing device 10A.

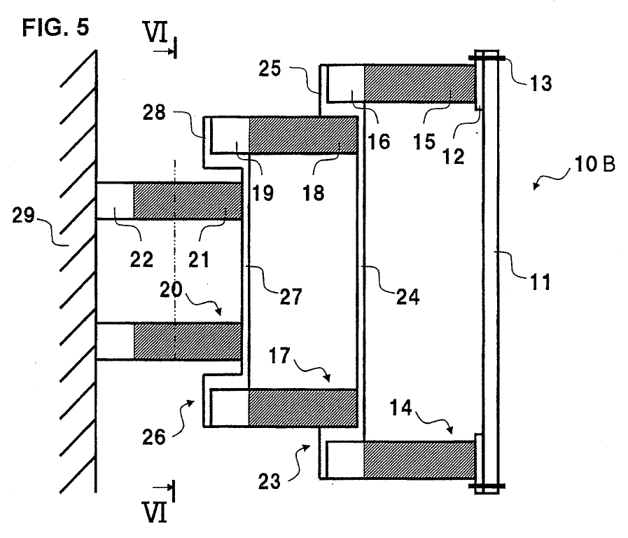

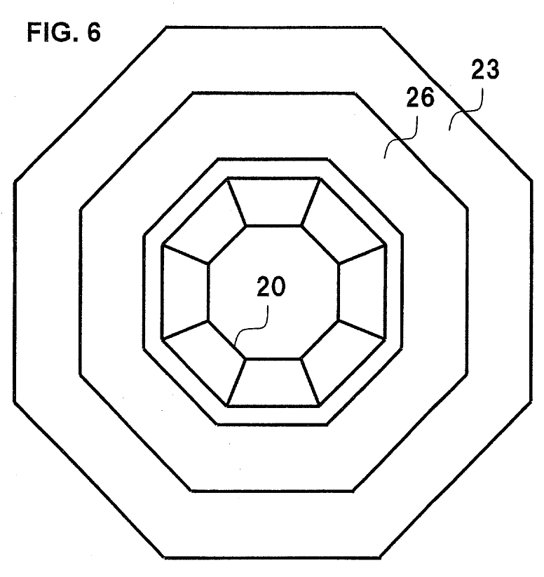

Another embodiment of the present invention will be described with reference to FIGS. 5 and 6.

A shock absorbing device 10B illustrated in FIGS. 5 and 6 have the horizontal positions of the load acting portion 11 and the base 29 reversed from the embodiment illustrated in FIG. 1.

According to this arrangement, the load acting portion 11 is widened, so that the shock absorbing device 10B can receive a wider range of load.

However, when vertical load or horizontal load is applied on the load acting portion 11, the strength thereof may become insufficient. Since the outer diameter of the shock absorber 20 is small, the strength for receiving such load may become insufficient compared to the embodiment of FIG. 1. Therefore, it is more preferable to adopt the structure illustrated in FIG. 1.

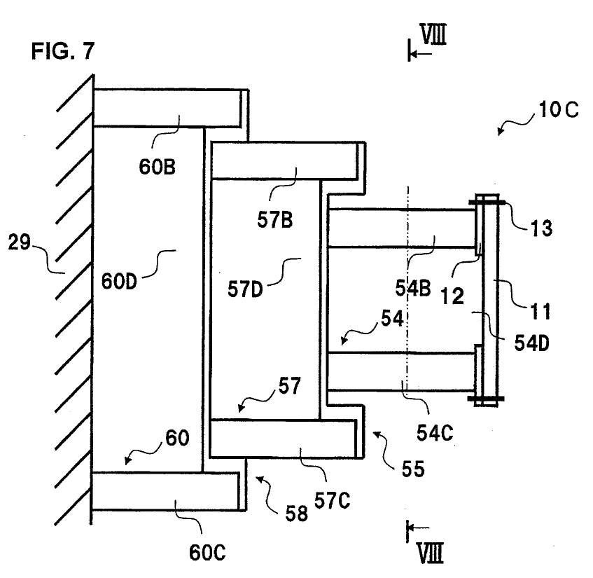

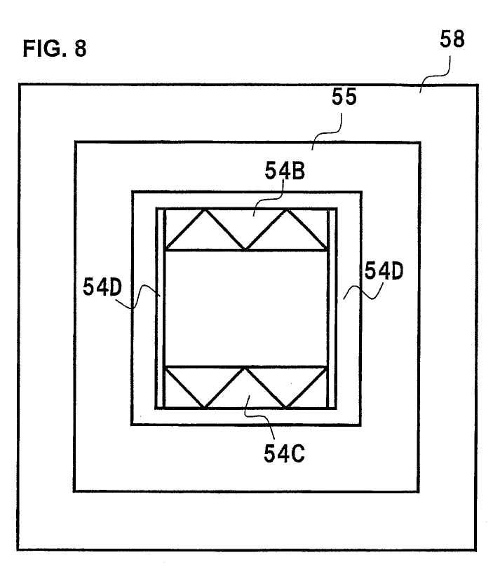

Next, another embodiment illustrated in FIGS. 7 and 8 will be described. The previous embodiments related to hollow extruded shape members having an octagonal cross-section, but a shock absorbing device 10C illustrated in FIG. 7 utilizes rectangular hollow extruded shape members. A shock absorber 54 (57, 60) is composed of two hollow shape members 54B and 54C (57B and 57C, 60B and 60C), which are disposed at two positions one above the other with the direction of extrusion thereof placed horizontally. The upper and lower hollow shape members 54B and 54C (57B and 57C, 60B and 60C) have their width-direction ends welded via plates 54D (57D, 60D). The term “width direction” corresponds to the width direction (horizontal direction) with respect to the direction of extrusion (load acting direction). Since the plates 54D (57D, 60D) integrate the hollow shape members 54B and 54C (57B and 57C, 60B and 60C), the hollow shape members 54B and 54C (57B and 57C, 60B and 60C) will collapse in an integrated manner. The plate thickness of the plates 54D (57D, 60D) is small.

The shock absorber 54 (57) and the shock absorber 57 (60) are connected via a connecting member 55 (58). The shapes of the connecting members 55 and 58 are not octagonal, but rectangular when viewed from the load acting direction. The depths of the connecting members 55 and 58 are substantially equal to the overlapped area between the shock absorber 54 (57) and the shock absorber 57 (60).

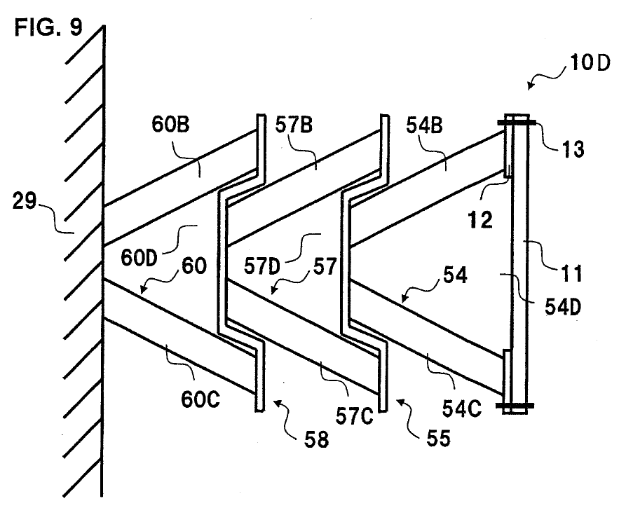

The embodiment of FIG. 9 will be described. In the embodiment of FIG. 8, the direction of extrusion of the hollow shape members 54B, 54C, 57B, 57C, 60B and 60C are along the load acting direction or horizontal direction, but according to a shock absorbing device 10D illustrated in FIG. 9, the direction of extrusion of the hollow shape members 54B, 54C, 57B, 57C, 60B and 60C are slanted with respect to the load acting direction or horizontal direction. The hollow shape members 54B, 54C, 57B, 57C, 60B and 60C are connected to plates 54D, 57D and 60D via welding. The other arrangements are the same as those of the aforementioned embodiment illustrated in FIGS. 7 and 8. According to the present embodiment, it becomes possible to shrink the space required to dispose the shock absorbing device 10D.

Though the shock absorbers are composed of hollow extruded shape members according to the aforementioned embodiments, they can be composed of members other than hollow members.

What is claimed is:

1. A transportation device having a shock absorbing device composed of a shock absorber for absorbing shock, wherein
the shock absorbing device comprises a plurality of said shock absorbers disposed in a shock acting direction;
with respect to two shock absorbers of the plurality of shock absorbers constituting the shock absorbing device, a rear end portion of a shock absorber disposed frontward in the shock receiving direction is inserted to and overlapped with a front end portion of the shock absorber disposed rearward therefrom; or
the rear end portion of the shock absorber disposed frontward in the shock receiving direction covers and overlaps with the front end portion of the shock absorber disposed rearward therefrom; and
the frontward shock absorber and the rearward shock absorber are connected via a connecting member along the shock acting direction.

2. A transportation device having a shock absorbing device composed of a shock absorber for absorbing shock, wherein
the shock absorbing device comprises a plurality of said shock absorbers disposed in a shock acting direction;
with respect to two shock absorbers of the plurality of shock absorbers constituting the shock absorbing device, a rear end portion of a shock absorber disposed frontward in the shock receiving direction is inserted to and overlapped with a front end portion of the shock absorber disposed rearward therefrom; or
the rear end portion of the shock absorber disposed frontward in the shock receiving direction covers and overlaps with the front end portion of the shock absorber disposed rearward therefrom;
the frontward shock absorber and the rearward shock absorber are connected via a connecting member along the shock acting direction; and
the shock absorber is composed of an extruded shape member having a direction of extrusion thereof corresponding to the shock acting direction.

3. The transportation device according to claim 2, wherein
the extruded shape member is a hollow extruded shape member having a hexagonal or octagonal polygonal cross-section or a circular cross-section in a perpendicular direction with respect to the direction of extrusion;
with respect to two hollow extruded shape members of the shock absorbing device composed of the plurality of shock absorbers, a rear end portion of a hollow extruded shape member disposed frontward is inserted to and overlapped with a front end portion of the hollow extruded shape member disposed rearward therefrom;
the outer diameters of the plurality of hollow extruded shape members are increased gradually toward the rear; and
the hollow extruded shape members have spaces running through center portions along the direction of extrusion thereof.

4. The transportation device according to claim 2, wherein
the extruded shape member is a hollow extruded shape member having a hexagonal or octagonal polygonal cross-section or a circular cross-section in a perpendicular direction with respect to the direction of extrusion;
with respect to two hollow extruded shape members of the shock absorbing device composed of the plurality of shock absorbers, a rear end portion of a hollow extruded shape member disposed frontward covers and overlaps with a front end portion of the hollow extruded shape member disposed rearward therefrom;
the outer diameters of the plurality of hollow extruded shape members are reduced gradually toward the rear; and
the hollow extruded shape members have spaces running through center portions along the direction of extrusion thereof.

5. The transportation device according to claim 2, wherein
one of the shock absorbers constituting the shock absorbing device is composed of two hollow extruded shape members and a connecting plate connecting width-direction ends of the two hollow extruded shape members; and
the direction of extrusion of the hollow extruded shape members corresponds to the shock acting direction.

6. The transportation device according to claim 2, wherein
one of the shock absorbers constituting the shock absorbing device is composed of two hollow extruded shape members and a connecting plate connecting width-direction ends of the two hollow extruded shape members;
the direction of extrusion of the hollow extruded shape members corresponds to the shock acting direction; and
the hollow extruded shape members are disposed in parallel.

7. The transportation device according to claim 2, wherein
one of the shock absorbers constituting the shock absorbing device is composed of two hollow extruded shape members and a connecting plate connecting width-direction ends of the two hollow extruded shape members;
the direction of extrusion of the hollow extruded shape members corresponds to the shock acting direction; and
the hollow extruded shape members are arranged so that the direction of extrusion thereof is slanted with respect to other hollow extruded shape members.
